(19) United States
(12) Patent Application Publication
(10) Pub. No.: US 2008/0085944 A1
(43) Pub. Date: Apr. 10, 2008

(54) Support part on the basis of foam material, and method for the production of such a support part

(76) Inventor: Kai Hirsch, Cologne (DE)

Correspondence Address: COLLARD & ROE, P.C., 1077 NORTHERN BOULEVARD, ROSLYN, NY, 11576, US

(21) Appl. No.: 11/904,948

(22) Filed: Sep. 28, 2007

(30) Foreign Application Priority Data
Sep. 29, 2006 (DE) 10 2006 046 537.7

(51) Int. Cl. C08F 110/02

(52) U.S. Cl. 521/143

(57) ABSTRACT

The invention relates to a support part (1) on the basis of foam material, for use in the medical sector, such as, for example, in operating rooms, particularly a head support, whereby the support part (1) has a hard foam material core (2), which is covered with a soft foam material layer (4), as well as furthermore to the production of such a support part. In order to further improve a support part of the type in question with regard to functionality and use, it is provided that furthermore, the soft foam material layer (4) is surrounded by an outer sheath (6). In terms of the method, it is provided that at least one support part outer sheath (6) is laminated onto a soft foam material layer (4) and preformed in a deep-drawing mold, and this laminate is afterwards drawn over the hard foam material core (2).

The invention first of all relates to a support part on the basis of a foam material, for use in the medical sector, such as, for example, in operating rooms, particularly a head support, whereby the support part has a hard foam material core, which is covered with a soft foam material layer.

Support parts, particularly head supports of the type in question, are known. They are particularly used in the medical sector, furthermore in operating rooms, to fix the head or another body part in a selected position. Known embodiments exist for stable positioning of the body part, made of a hard foam material core, which is furthermore preferably covered with a soft foam material layer.

With regard to the state of the art as described above, a technical set of problems of the invention is seen in further improving a support part of the type in question, with regard to functionality and use.

This set of problems is solved, first of all and essentially, by means of the object of claim 1, whereby the claim is directed at the fact that furthermore, the soft foam material layer is surrounded by an outer sheath. As a result of this configuration, a protective covering, particularly for the sensitive soft foam material layer, is provided by means of the arrangement of the outer sheath. Quality standards, such as appearance, possibly a fluid-sealed configuration, greater resistance to cuts, or also avoidance of color changes, can thereby be adhered to more easily.

In the following, characteristics are described that preferably have significance in combination with the characteristics of claim 1, but fundamentally also can have significance with only some characteristics of claim 1, or alone.

Thus, in an advantageous further development of the object of the invention, it is provided that the outer sheath is laminated onto the soft foam material layer. Therefore no relative displacement of the plies (outer sheath and soft foam material layer) is possible. The outer sheath assumes the shape of the soft foam material layer disposed underneath it and laminated to it, so that the contour of the latter is reflected on the outside, on the outer sheath. Furthermore, full-area contacting of the outer sheath with the soft foam material layer is assured by means of the lamination. Air cushions that are enclosed in uncontrolled manner, such as those that can occur when outer sheaths are drawn on in the usual manner, are reliably avoided. Lamination takes place under the effect of heat on the two plies, thereby producing a connection that is inseparable after cooling, at least not separable without destruction.

The support part is furthermore stabilized in that the outer sheath laminated to the soft foam material layer is also drawn onto the hard foam material core and laminated to it. In this connection, the hard foam material core essentially determines the shape of the head support. A full-area adaptation of outer sheath and soft foam material core in accordance with the profiling of the core results from lamination of the subsequent plies onto the core. This laminated connection is also not separable, or at least not separable without destruction.

The outer sheath can consist, for example, of a plastic material; accordingly, it can be configured in the manner of a plastic film. In this regard, a configuration is preferred in which the outer sheath consists of imitation leather. Imitation leather is understood to mean a laminate of a woven textile with a plastic coating. These are woven textiles made of natural fibers or synthetic fibers, which are coated with a soft polyurethane layer. This coating can also be structured in foamed manner. Also, it can be provided with carbon black, for example, to provide electrical conductivity. In general, the surface of so-called imitation leather is scarred, so that it corresponds to a leather texture. Such a ply of imitation leather can furthermore contribute to making the support part water-tight.

The soft foam material layer preferably consists of a thermoplastic synthetic material, furthermore preferably of polyethylene. Any seams that might be provided in the outer sheath are achieved by means of edge-side compression and thermoplastic deformation.

The hard foam material core preferably consists of an expanded thermoplastic synthetic material, for example particularly of expanded polyethylene. Alternatively, a pre-foamed polyurethane core is also possible.

As a result of this configuration, a support part having increased usage and functionality value is created. Imitation leather proves itself to be an advantageous material for configuring the outer sheath, in this regard, since it offers increased resistance to cuts, so that damage, which could lead to dirt pockets, for example, is avoided. Furthermore, cleaning of a cushion-like part created in this manner, a support part, for example by means of washing the outer sheath off, is significantly facilitated by the liquid-tight configuration that is also created; this goes as far as cleaning with disinfectants. The invention furthermore relates to a method for the production of a support part on the basis of a foam material, for use in the medical sector, such as, for example, in operating rooms, whereby the support part, particularly a head support, has a hard foam material core.

Support parts of the type in question are known, as described initially.

In order to further develop a method of the type in question, with regard to the production of a support part that is improved functionally and in terms of usage technology, in advantageous manner, it is proposed that first, a support part outer sheath is laminated to a soft foam material layer and pre-formed, in a deep-drawing mold, and this laminate is afterwards drawn over the hard foam material core. A laminate is achieved by means of laminating the soft foam material layer onto the inside of the outer sheath. Afterwards, outer sheath and soft foam material layer are connected firmly with one another so as to be inseparable, at least not separable without destruction, so that the profiling of the soft foam material layer is reflected on the outside, on the outer sheath. This profiling furthermore corresponds to the profiling of the hard foam material core covered with the laminate. For this purpose, the outer sheath is first held in a deep-drawing mold, particularly under the effect of partial vacuum, and the soft foam material layer is laminated to it in this position. This results in a base body laminate that is stable in shape, although it is soft. This laminate is then drawn onto the hard foam material core, which is produced separately.

In the following, characteristics are described that preferably have significance in combination with the characteristics of claim 9, but fundamentally also can have significance with only some characteristics of claim 9, or alone.

Thus, it is furthermore provided that the hard foam material core covered with the laminate has heat applied to it while it is lying in a mold, in order to laminate the foam material side of the laminate to the hard foam material core. This results in a further full-area laminate connection, so that the support part consisting of three plies lying on top of one another (hard foam material core, soft foam material layer, and outer sheath) behaves in shape-stable manner, in the manner of a one-piece support part, as a result of the lamination of the individual plies to one another. No displacements of the plies relative to one another occur as the result of forces that act from the outside. Furthermore, the inclusion of undesirable air cushions is avoided by means of the full-area lamination, in each instance. A particularly good laminate connection between the foam material plies, i.e. between the surface of the hard foam material core and the facing inner side of the soft foam material layer, is achieved under the effect of heat at 130° to 200° C., preferably 160° C.

The outer sheath can consist, for example, of a plastic material; accordingly, it can be configured in the manner of a plastic film. In this regard, a configuration is preferred in which the outer sheath consists of imitation leather. Imitation leather is understood to mean a laminate of a woven textile with a plastic coating. These are woven textiles made of natural fibers or synthetic fibers, which are coated with a soft polyurethane layer. In the present case, this coating is preferably structured in foamed manner, and can be provided with carbon black, for example, to provide electrical conductivity. In general, the surface of so-called imitation leather is scarred, so that it corresponds to a leather texture. Such a ply of imitation leather can furthermore contribute to making the head support water-tight.

The soft foam material layer preferably consists of a thermoplastic synthetic material, furthermore preferably of polyethylene. Any seams that might be provided in the outer sheath are achieved by means of edge-side compression and thermoplastic deformation.

The hard foam material core preferably consists of an expanded thermoplastic synthetic material, for example particularly of expanded polyethylene.

Furthermore, the invention will be explained in greater detail below, using the attached drawing, which represents an embodiment merely as an example. This shows:

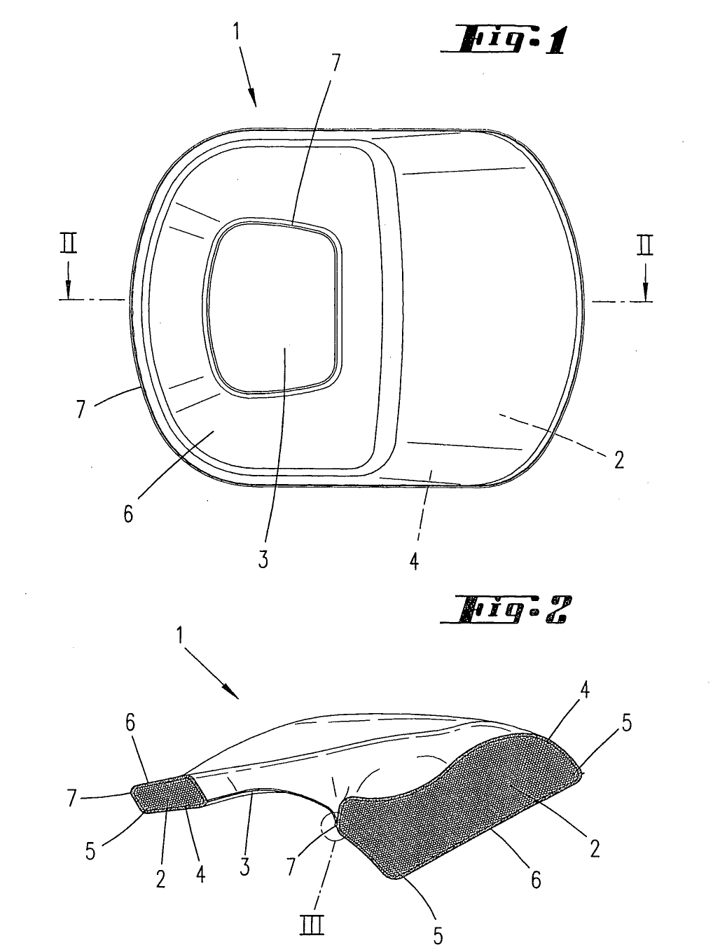

FIG. 1 a support part according to the invention in a top view;

FIG. 2 the section along the line II-II in FIG. 1;

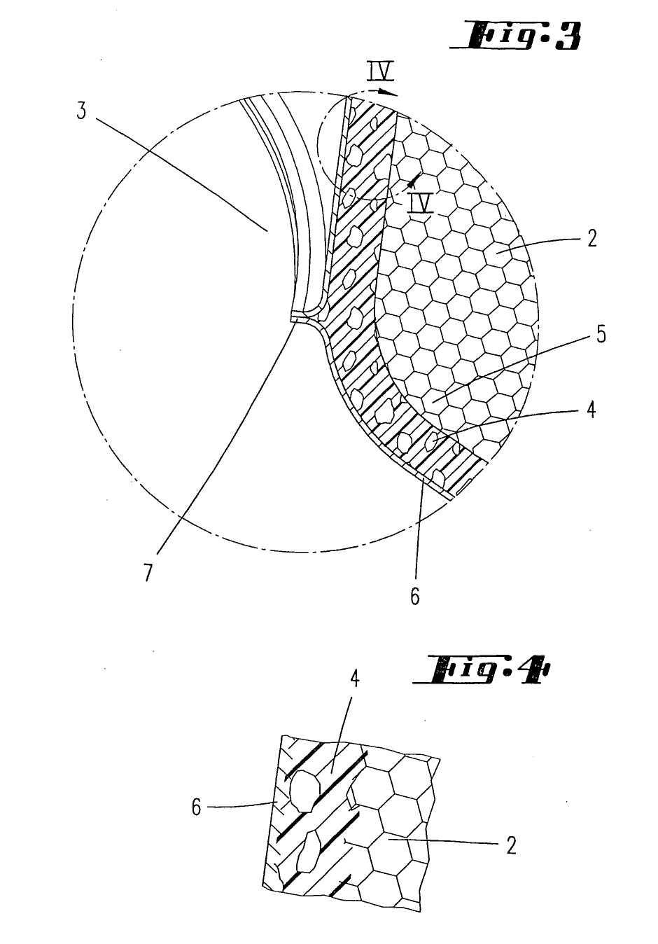

FIG. 3 the enlargement of the region III in FIG. 2;

FIG. 4 the additional enlargement of the region IV in FIG. 3.

First of all, with reference to FIG. 1, a head support 1 for use in the medical sector is shown and described. In deviation from this, this could also be a foot support or arm support, for example.

This head support 1 first of all consists of a hard foam material core 2 on the basis of an expanded thermoplastic synthetic material, for example particularly of expanded polyethylene.

This hard foam material core 2 has a material-surrounded window 3 in an outline according to the representation in FIG. 1. Accordingly, the core is structured approximately in ring shape.

Depending on the desired surface profiling, the hard foam material core 2 is provided with different heights, considered over its area expanse. This results in a surface profiling of the core 2 in the manner of peaks and valleys.

The hard foam material core 2 is covered over its full area, i.e. also facing the window edge, with a soft foam material layer 4, preferably consisting of polyethylene. If the thickness of the hard foam material core 2 is between 10 and 150 mm, depending on the profiling, the soft foam material layer 4 is provided with a thickness of approximately 3-8 mm, measured on the finished product, which thickness remains essentially the same throughout.

The resulting border edges 5 of the hard foam material core 2 are rounded off. The soft foam material layer 4 that is drawn on assumes the rounding.

The hard foam material core 2 surrounded by the soft foam material layer 4 on all sides in this manner is furthermore provided with an outer sheath 6. The latter is provided, assigned to the surface of the soft foam material layer 4 that faces away from the hard foam material core 2, over its full area, so that the outer sheath 6 completely surrounds the hard foam material core 2 and the soft foam material layer 4, doing so furthermore while projecting the hard foam material core contour towards the outside.

The material thickness of the outer sheath amounts to approximately 0.5-1.5 mm. In this regard, an imitation leather is preferred for the outer sheath 6, accordingly, therefore, a laminate of woven textile and a soft polyurethane layer, which is furthermore preferably structured in foamed manner.

The individual plies (hard foam material core 2—soft foam material layer 4—outer sheath 6) are laminated to one another, lying on top of one another (see FIG. 4). As a result of this lamination, the plies are connected with one another so that they cannot be moved. Furthermore, because of the full-area lamination, inclusion of undesired air cushions or the like is counteracted. The cushion contour predetermined by the hard foam material core 2 is reflected on the outside of the outer sheath 6.

By means of appropriately equipping the outer sheath 6, for example by mixing carbon black particles into the polyurethane layer, the outer sheath 6 can furthermore be made electrically conductive. This is furthermore done to drain off electrical charges. Furthermore, the outer sheath 6 is made to be water-tight, and thus can be damp-wiped if any contamination occurs, or can be cleaned with a disinfectant.

The imitation leather outer sheath 6 is held in a deep-drawing mold, under partial vacuum, in order to laminate the soft foam material layer 4 onto its inside. The latter faces the sheath outside of the mold. The soft foam material layer 4 is laminated onto the sheath inside under the effect of heat. This results in a shape-stable laminate, although it is soft.

This laminate is drawn over the hard foam material core 2, which is produced separately, whereby possible seams 7 are formed by means of thermoplastic deformation of the edge region of the outer sheath 6, this furthermore with the simultaneous inclusion of the corresponding edge sections of the soft foam material layer 4.

The hard foam material core 2, covered with the laminate, is subsequently subjected to heat, lying in a mold, to achieve full-area lamination of the inside of the soft foam material layer 4, which faces away from the outer sheath 6, to the hard foam material core surface. This lamination takes place at 160° C., for example.

All of the lamination processes take place over the full area, encompassing all sides.

All of the characteristics disclosed are essential to the invention (in and of themselves). The disclosure content of the related/attached priority documents (copy of the prior application) is hereby also included in the disclosure of the application, with its full content, also for the purpose of incorporating characteristics of these documents in claims of the present application.

1: Support part (1) on the basis of foam material, for use in the medical sector, such as, for example, in operating rooms, particularly a head support, whereby the support part (1) has a hard foam material core (2), which is covered with a soft foam material layer (4), wherein the soft foam material layer (4) is furthermore surrounded by an outer sheath (6).

2: Support part according to claim 1, wherein the outer sheath (6) is laminated onto the soft foam material layer (4).

3: Support part according to claim 1, wherein the outer sheath (6) laminated onto the soft foam material layer (4) is drawn onto the hard foam material core (2) and laminated to it.

4: Support part according to claim 1, wherein the outer sheath (6) consists of imitation leather.

5: Support part according to claim 1, wherein the soft foam material layer (4) consists of a thermoplastic synthetic material.

6: Support part according to claim 1, wherein the soft foam material layer (4) consists of polyethylene.

7: Support part according to claim 1, wherein the hard foam material core (2) consists of an expanded thermoplastic synthetic material.

8: Support part according to claim 1, wherein the hard foam material core (2) consists of expanded polyethylene.

9: Method for the production of a support part (1) on the basis of foam material, for use in the medical sector, such as, for example, in operating rooms, particularly a head support, whereby the support part has a hard foam material core (2), wherein first, a support part outer sheath (6) is laminated onto a soft foam material layer (4) and preformed in a deep-drawing mold, and this laminate is afterwards drawn over the hard foam material core (2).

10: Method according to claim 9, wherein the hard foam material core (2) covered with the laminate has heat applied to it while lying in a mold, to laminate the foam material side of the laminate to the hard foam material core (2).

11: Method according to claim 9, wherein the lamination takes place under the effect of heat at 130° to 200° C., preferably 160° C.

12: Method according to claim 9, wherein the outer sheath (6) consists of imitation leather.

13: Method according to claim 9, wherein the soft foam material layer (4) consists of a thermoplastic synthetic material.

14: Method according to claim 9, wherein the soft foam material layer (4) consists of polyethylene.

15: Method according to claim 9, wherein the hard foam material core (2) consists of an expanded thermoplastic synthetic material.

16: Method according to claim 9, wherein the hard foam material core (2) consists of expanded polyethylene.
